(19) United States
(12) Patent Application Publication
(10) Pub. No.: US 2021/0161624 A1
(43) Pub. Date: Jun. 3, 2021

(54) DENTAL PROSTHESIS

(71) Applicant: TRI Dental Implants Int. AG, Hunenberg (CH)

(72) Inventors: Sandro VENANZONI, Zürich (CH); Rafael PEREZ, Freiburg (DE); Holger KAST, Hünenberg (CH)

(21) Appl. No.: 17/169,976

(22) Filed: Feb. 8, 2021

Related U.S. Application Data
(63) Continuation of application No. PCT/EP2019/066960, filed on Jun. 26, 2019.

(30) Foreign Application Priority Data
Aug. 27, 2018 (DE) 10 2018 120 901.0
Aug. 27, 2018 (DE) 20 2018 104 914.3

(51) Int. Cl. A61C 8/00; A61C 13/00

(52) U.S. Cl. CPC A61C 8/0074; A61C 8/0069; A61C 13/0019; A61C 8/0028; A61C 8/0068

(57) ABSTRACT

Dental prosthesis comprising a dental implant comprising an external thread for screwing the dental implant into a jawbone and an internal thread arranged inside the dental implant. The dental prosthesis further comprises a superstructure having an internal bore and a screw for fastening the superstructure to the dental implant. The screw has a screw head with a cylindrical or conical lateral surface and a shank which adjoins a lower end of the screw head and on which an external thread is arranged. In an assembled state of the dental prosthesis, the screw is inserted through the internal bore of the superstructure into the dental implant and the external thread of the screw engages the internal thread of the dental implant. The screw head comprises a convexly rounded chin between the cylindrical or conical lateral surface and its lower end, with which chin the screw abuts the superstructure in the internal bore in the assembled state of the dental prosthesis.

### CROSS REFERENCE TO RELATED APPLICATIONS

This application is a continuation of international patent application PCT/EP2019/066960, filed on Jun. 26, 2019 designating the U.S., which international patent application has been published in German language and claims priority from German patent application DE 10 2018 120 901.0, filed on Aug. 27, 2018, and from German utility model application DE 20 2018 104 914.3, filed on Aug. 27, 2018. The entire contents of these priority applications are incorporated herein by reference.

### BACKGROUND

This disclosure relates to a dental prosthesis. More specifically, the disclosure relates to a dental prosthesis in which a superstructure is directly connected to a dental implant by means of a screw, i.e. without the otherwise customary use of an interposed abutment.

An exemplary dental prosthesis of this type is disclosed in German patent application 10 2018 113 237.9 filed by the applicant.

The term “dental implant” is colloquially often used inconsistently and often erroneously for the overall structure of a dental prosthesis. Therefore, it should be clarified at this point that a “dental implant” in the medical and present sense is understood to mean only the implant body, i.e. the artificial tooth root that is implanted in the patient's jaw. Therefore, the term “implant body” is often used instead of the term “dental implant”. In the following, however, the term “dental implant” is uniformly used for the aforesaid part of the dental prosthesis.

Conventional dental prostheses comprise a so-called abutment in addition to the dental implant, which abutment acts as a connecting part between the dental implant and the implant crown (superstructure). The abutment forms the sensitive transition through the peri-implant soft tissue to the oral cavity and the superstructure. Such abutments are sometimes also referred to as “pillars” or “implant posts”. Commonly, abutments are made of titanium, ceramic or ceramic composites such as aluminum oxide or zirconium dioxide ceramic.

The superstructure, i.e. the artificial tooth crown, is typically made of ceramic or a comparable material. Traditionally, the superstructure is fabricated by a dental technician as follows: First, a wax model is created for the artificial dental crown. Then, the wax model is used to cast the artificial tooth crown. The abutment is manually ground down to the correct size and shape, and in the final step the cast artificial tooth crown is mounted on the abutment. In most cases, the assembly is done by bonding the superstructure to the abutment. This process, which is largely performed manually, allows highly precise results to be achieved. However, it goes without saying that this is time-consuming and therefore also cost-intensive. Additionally, there is an adhesive gap between the superstructure and the abutment, which gap is susceptible to leaks and can also limit the durability of the dental prosthesis.

Today, there are many efforts to digitize or automate the above-mentioned process as far as possible. The superstructure is now often milled on a milling machine on the basis of a 3D model. In this type of fabrication, the connection geometry for the connection with the abutment is inserted directly into the superstructure on its rear side. The shape and size of the abutment must therefore already be known when the artificial tooth crown is fabricated in order to program the milling machine accordingly. This is usually done by means of a CAD model of the abutment, which is read into the control system of the milling machine.

Since the shape and size of the abutment must be known before fabricating the superstructure, many manufacturers choose a short and small abutment that fits any anatomy. However, in the case of elongated, i.e. comparatively long superstructures, a short and small abutment is biomechanically unsuitable in relation to the superstructure, which may result in loosening or fractures.

Other manufacturers solve this by using many different abutments. Depending on the shape and size of the superstructure, abutments of different sizes or shapes are then used. For example, a different abutment has to be used for an artificial incisor than for an artificial molar tooth. If, for example, the rear flank of the abutment is not beveled when used for an artificial incisor, the abutment would be visible on the rear side of the superstructure, which is undesirable from a purely esthetic point of view. However, this problem may not arise when used for an artificial molar tooth.

In automated manufacturing with digital CAD models, the manufacturer of the superstructure is usually provided with several CAD data sets that represent the different shapes of the abutments. At the same time, the manufacturer of the superstructure has to keep a large number of abutments of different shapes and sizes in stock. This is often cumbersome and also generates high storage costs.

The disadvantages of the previous approaches can thus be summarized as follows: On the one hand, the use of abutments restricts the freedom of shape and design of the superstructure including its transgingival portion. A non-flexible transgingival portion of the superstructure can cause problems, particularly with soft tissue management. However, ideal soft-tissue management is crucial for an esthetic result and a long-term stable bone level. On the other hand, the material and manufacturing costs for such a dental prosthesis according to the prior art are relatively high. In addition, there is an adhesive gap between the superstructure and the abutment, which gap is disadvantageous in many respects.

In the patent application 10 2018 113 237.9 mentioned at the outset, a completely new approach is presented in which a dental prosthesis also works without an abutment. For this purpose, the dental implant has a specially shaped interface which allows the superstructure to be attached directly and immediately to the dental implant. Due to the special design of this interface, the superstructure can be arranged in a clearly defined manner at the interface of the dental implant. This enables a clearly defined relative position between the superstructure and the dental implant.

The interface between superstructure and dental implant presented in patent application 10 2018 113 237.9 enables a stable and tight direct connection between the superstructure and the dental implant. In addition, the interface is very easy and inexpensive to manufacture, as it can be automated on a milling machine without major problems. The shape of the interface meets all mechanical requirements for a direct connection of titanium (typical material from which the dental implant is made) and ceramics (typical material from which the superstructure is made). The shape of the interface also meets the requirements for a direct connection of titanium to titanium, for a case where both the superstructure and the dental implant are made of titanium. In addition, the interface is suitable for the manufacturing process mentioned at the beginning of this article, in which manufacturing process the superstructure is manufactured automatically using a CAD model (for example, by machining or additive manufacturing processes).

Although the direct connection between the superstructure and the dental implant has proven to be extremely advantageous, there is still cause for technical improvement of this type of direct connection.

### SUMMARY

It is an object to provide a dental prosthesis, in which the connection between the superstructure and the dental implant is further improved. In particular, it is an object to improve the connection technique with regard to its stability and sustainability.

According to an aspect, a dental prosthesis is provided comprising the following components:
a dental implant having an external thread for screwing the dental implant into a jawbone and having an internal thread arranged inside the dental implant;
a superstructure having an internal bore; and
a screw for fastening the superstructure to the dental implant, wherein the screw comprises a screw head having a cylindrical or conical lateral surface and a shank which adjoins a lower end of the screw head and on which an external thread is arranged,
wherein, in the assembled state of the dental prosthesis, the screw is inserted through the internal bore of the superstructure into the dental implant and the external thread of the screw engages the internal thread of the dental implant, and
wherein the screw head comprises a convexly rounded chin between the cylindrical or conical lateral surface and its lower end, with which chin the screw abuts the superstructure in the internal bore in the assembled state of the dental prosthesis.

An improvement of the presented dental prosthesis can be seen in particular in the configuration of the screw which connects the superstructure to the dental implant. The screw head of the screw has a convex rounded chin at its lower end, with which the screw abuts the superstructure in the internal bore in the assembled state of the dental prosthesis. This convexly rounded chin of the screw head improves the transmission of force between the screw and the superstructure. Due to the rounding at the lower end of the screw head (at the chin of the screw head), the force exerted by the screw can be ideally transferred to the superstructure. Unwanted shear forces can thus be avoided. Since the superstructure is preferably made of ceramic, undesirable crack formation within the superstructure can thus be avoided.

Another advantage of the screw head, which, in addition to the rounded chin, comprises a cylindrical or conical lateral surface above it, is the resulting improved stability of the connection between the screw and the superstructure. Unwanted relative movements between the superstructure and the screw, which could otherwise occur over time, can be effectively avoided by the specially shaped screw head, which abuts the superstructure in the assembled state of the dental prosthesis.

The convexly rounded chin also has the advantage that the interface between the screw and the superstructure is easier to produce. The superstructure preferably comprises a correspondingly shaped, concavely rounded abutment surface at the joint with the screw within the internal bore, with which abutment surface the chin of the screw abuts the superstructure. Both the convex rounded chin and the counterpart concave rounded contact surface in the internal bore of the superstructure can be produced very easily by means of a milling machine. The roundings can be produced much more easily and therefore more cost-effectively on a milling machine, particularly in contrast to sharp-edged or angular interfaces.

The term “convexly rounded” is understood in this context to mean an outwardly curved curvature. The term “concave rounded”, on the other hand, is understood to mean an inwardly curved depression. For clarification purposes only, the term “rounded” is used in addition to the terms “convex” and “concave”, although the terms “convex” and “concave” already imply such a rounding or roundness. The convexly rounded chin and the concavely rounded abutment surface on the superstructure acting as a counterpart preferably each have a continuous tangent slope (without “kink”).

It should also be mentioned here that the term “internal bore” should be interpreted broadly in this context, as it is not necessarily necessary to produce this bore by means of a drill. The internal bore can just as easily be produced on a milling machine or, in the case of additive manufacturing of the superstructure, directly during manufacture as a recess. The internal hole is therefore generally understood to be a channel-like opening through which the screw can be inserted through the superstructure into the dental implant. Typically, this channel-like opening or internal hole is closed on its upper side after the superstructure has been connected to the dental implant so that a closed or sealed superstructure is created.

As already mentioned, the superstructure directly abuts the dental implant in the assembled state of the dental prosthesis. More precisely, the lower side of the superstructure preferably abuts the upper side of the dental implant. Preferably, no abutment is used here, which forms the transition between the superstructure and the dental implant as is otherwise customary. The interface between the dental implant and the superstructure can, for example, be designed as already presented in German patent application 10 2018 113 237.9. However, without leaving the spirit and scope of the present disclosure, interfaces of a different shape may be provided, which enable direct connection of the superstructure to the dental implant without an abutment.

According to a refinement, the chin of the screw head has a round cross-section.

Such a round chin enables an ideal force transmission into the superstructure, since the forces are then transmitted into the superstructure exactly radially at the chin. In addition, a round chin is very easy to fabricate with a milling machine.

Particularly preferably, the round cross-section has a radius of 0.5 mm. For the manufacture of the chin, a ball cutter is preferably used, which typically has a diameter of 1 mm, so that a radius of 0.5 mm is easiest to produce with this ball cutter.

According to a further refinement, the cylindrical or conical lateral surface of the screw head abuts the superstructure in the internal bore.

The internal bore is preferably also cylindrical at this position and has the same diameter or only a slightly larger diameter as the cylindrical or conical lateral surface of the screw head. This additionally improves the stability of the connection between the screw and the superstructure.

According to a further refinement, the shank comprises, in an upper region adjacent the lower end of the screw head, a non-threaded cylindrical portion that abuts the dental implant in the assembled state of the dental prosthesis.

For this purpose, the dental implant comprises a correspondingly cylindrically shaped abutment surface in the area of its upper end, i.e. above the internal thread arranged inside the dental implant, against which abutment surface the aforementioned cylindrical portion of the screw shank rests. This cylindrical portion turns the screw into a stable post within the dental implant, which can additionally support the superstructure. This is particularly advantageous with regard to the stability of the connection between the dental implant and the superstructure and provides additional support, which is particularly beneficial when the superstructure is made of a relatively soft material.

The cylindrical portion of the shank preferably has a diameter equal to a nominal diameter of the external thread of the screw.

According to a further refinement, the screw head has its largest diameter in the region of the cylindrical or conical lateral surface.

The screw head, as mentioned above, preferably abuts the superstructure in the internal bore over the entire surface along its cylindrical or conical lateral surface and its rounded chin arranged at the lower end.

The superstructure is preferably made of ceramic. Particularly preferably, the superstructure is manufactured on a milling machine using a 3D model.

According to a further refinement, the screw head has at its lower end an abutment surface which is oriented transversely to a longitudinal axis of the screw and abuts a mating abutment surface of the superstructure in the assembled state of the dental prosthesis. The term “transverse” is herein understood to mean any position at an angle not equal to 0°, i.e. not parallel. Preferably, the abutment surface is oriented at an angle larger than 60° to the longitudinal axis of the screw. Particularly preferably, the abutment surface is oriented orthogonally to the longitudinal axis of the screw.

The advantage of this abutment surface is that forces can be transmitted in the axial direction and the superstructure is pulled down onto the dental implant. This greatly improves the stability of the connection between the superstructure and the dental implant.

The mating abutment surface arranged on the superstructure is preferably also oriented orthogonally to the longitudinal axis of the dental prosthesis. In the assembled state, the abutment surface preferably flatly or at least linearly abuts the mating abutment surface.

The abutment surface preferably adjoins the convexly rounded chin. Particularly preferably, the abutment surface and the mating abutment surface are each an annular-shaped surface.

It is evident that the above-mentioned features and those yet to be explained can be used not only in the combination indicated in each case, but also in other combinations or on their own, without departing from the spirit and scope of the present disclosure.

### BRIEF DESCRIPTION OF THE DRAWINGS

FIG. 1 shows a sectional view of an embodiment of the dental prosthesis;

FIG. 2 shows a perspective view of an exemplary dental implant that can be used in the dental prosthesis;

FIG. 3 shows a top view of the exemplary dental implant shown in FIG. 2;

FIG. 4 shows a longitudinal sectional view of the exemplary dental implant shown in FIG. 2;

FIG. 5 shows a perspective view of another exemplary dental implant that can be used in the dental prosthesis;

FIG. 6 shows a top view of the exemplary dental implant shown in FIG. 5;

FIG. 7 shows a longitudinal sectional view of the exemplary dental implant shown in FIG. 5;

FIG. 8 shows a perspective detail view of an underside of a superstructure matching the dental implant shown in FIGS. 2-4;

FIG. 9 shows a perspective detail view of an underside of a superstructure matching the dental implant shown in FIGS. 5-7; and

FIG. 10 shows a sectional view of a second embodiment of the dental prosthesis.

### DESCRIPTION OF PREFERRED EMBODIMENTS

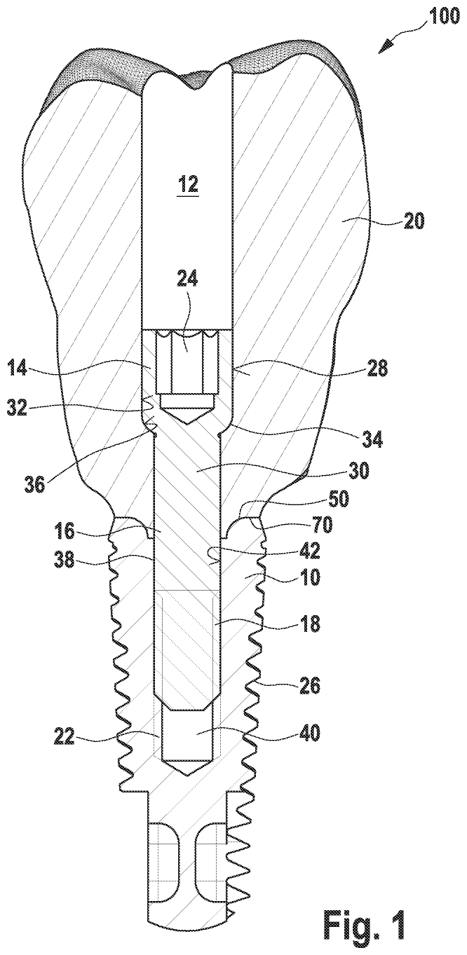

FIG. 1 shows an embodiment of the dental prosthesis in a longitudinal sectional view. The dental prosthesis is denoted in its entirety with the reference numeral 100.

The dental prosthesis 100 comprises a dental implant 10 to which a superstructure 20 (artificial tooth crown) is attached by means of a screw 30. Unlike conventional dental prostheses of this type, the superstructure 20 is directly connected to the dental implant 10 without an abutment arranged in between. The underside of the superstructure 20 therefore directly abuts the upper side of the dental implant 10.

The screw 30 is inserted into the dental implant 10 through an internal hole 12 in the superstructure 20. This hole 12 is preferably designed as a through hole, which is closed again after the superstructure 20 is connected to the dental implant 10. The screw 30 comprises a screw head 14, at the lower end of which a shank 16 adjoins. An external thread 18 is arranged at the lower edge of the shank 16, which external thread engages in a corresponding internal thread 22 arranged in the dental implant 10 in the assembled state of the dental prosthesis 100. A tool engagement 24 arranged in the screw head 14 is used to tighten the screw 30 by means of a suitable tool wrench.

The dental implant 10 comprises an external thread 26 on its outer side, by means of which the dental implant 10 can be screwed into a patient's jawbone. Therefore, the dental implant 10 is typically first mounted in the patient's jawbone before the superstructure 20 is attached to the dental implant 10 using the screw 30. Then, the top of the hole 12 is closed and sealed so that neither moisture nor dirt can enter the interior of the superstructure.

The dental implant 10 is typically made of titanium or zirconium oxide. The superstructure 20 is usually made of ceramic, although in principle it can also be made of titanium or zirconium oxide. The screw 30 is preferably also made of titanium or, alternatively, steel. All three components 1, 20, 30 are preferably manufactured automatically by means of a CAD data set by milling, particularly preferably by means of a ball milling cutter.

To create a particularly rigid and stable connection, the screw 30 has a special shape that is adapted to the respective parts of the superstructure 20 and the dental implant 10 against which the screw 30 rests.

The screw head 14 comprises a cylindrical lateral surface 28 which, in the assembled state of the dental prosthesis 100, abuts the inner wall of the internal bore 12. At this position, the internal bore 12 comprises an inner wall portion 32 which is also cylindrical and serves as an abutment surface for the cylindrical lateral surface 28 of the screw head 14.

According to an alternative embodiment not explicitly shown here, the lateral surface 28 and the inner wall portion 32 can also be slightly conical in shape.

Below the cylindrical or conical lateral surface 28, the screw head 14 comprises a convexly rounded chin 34. This chin 34 is arranged in the region of the lower end of the screw head 14. The chin 34 forms, so to speak, the transition between the cylindrical or conical lateral surface 28 and the shank 16 of the screw 30.

Corresponding to the convexly rounded chin 34, the internal bore 12 is also rounded at this position. The internal wall of the bore 12 has a concavely rounded internal wall portion 36 at this position. The screw head 14 of the screw 30 thus preferably rests with its cylindrical or conical lateral surface 28 against the internal wall section 32 as well as with its convexly rounded chin 34 against the concave internal wall section 36. This leads to an optimum transmission of force from the screw 30 to the superstructure 20. In particular, due to the convexly rounded chin 34 of the screw head 14, undesirable shear forces that could, for example, lead to the formation of cracks within the superstructure 20 can be avoided. The force is applied in a radial direction relative to the outside of the screw head, so that a uniform application of force is achieved without undesirable stress peaks occurring at different contact points.

The chin 34 of the screw head 14 is preferably exactly round. Particularly preferably, the chin 34 has a radius of 0.5 mm. Such a round chin 34 with a radius of 0.5 mm can be manufactured very easily with the ball burs with a diameter of 1 mm typically used for manufacturing this dental prosthesis 100.

Above the external thread 18, i.e. between the screw head 14 and the external thread 18, the shank 16 of the screw 30 comprises a cylindrical portion 38 without a thread. A part of this cylindrical portion 38 abuts the dental implant 10 in the assembled state of the dental prosthesis 100. More specifically, this cylindrical portion 38 preferably lies flat against the inner wall of the bore 40 arranged in the dental implant 10, in which bore the internal thread 22 is arranged. Correspondingly, the inner wall of the bore 40 arranged in the dental implant 10 also comprises a cylindrical portion 42 without a thread. This cylindrical portion 42 is arranged above the internal thread 22. The contact of the cylindrical portion 38 of the screw shank 16 with the cylindrical portion 42 of the dental implant 10 creates a very stable connection between the screw and the dental implant 10. The screw is thus supported like a kind of post. This is particularly advantageous when relatively soft materials are used for the superstructure 20, as this improves the overall stability of the dental prosthesis 100.

The cylindrical portion 38 of the screw shank 16 has a diameter that is preferably equal to the nominal diameter of the external thread provided further down the screw shank 16. The nominal diameter denotes the largest diameter of the thread geometry.

The dental implant 10 extends substantially along a longitudinal axis 48, which may also be referred to as central axis (see FIG. 4). The bore 40 running inside the dental implant extends along the longitudinal axis 48. Preferably, the bore 40 is configured as a blind bore.

The dental implant 10 comprises an interface 50 (hereinafter also referred to as “first interface 50”) at the upper front end. This interface 50 serves to attach the superstructure 20 to the dental implant 10. The interface 50 so to speak forms the contact surface with which the dental implant 10 contacts the superstructure 20 in the assembled state.

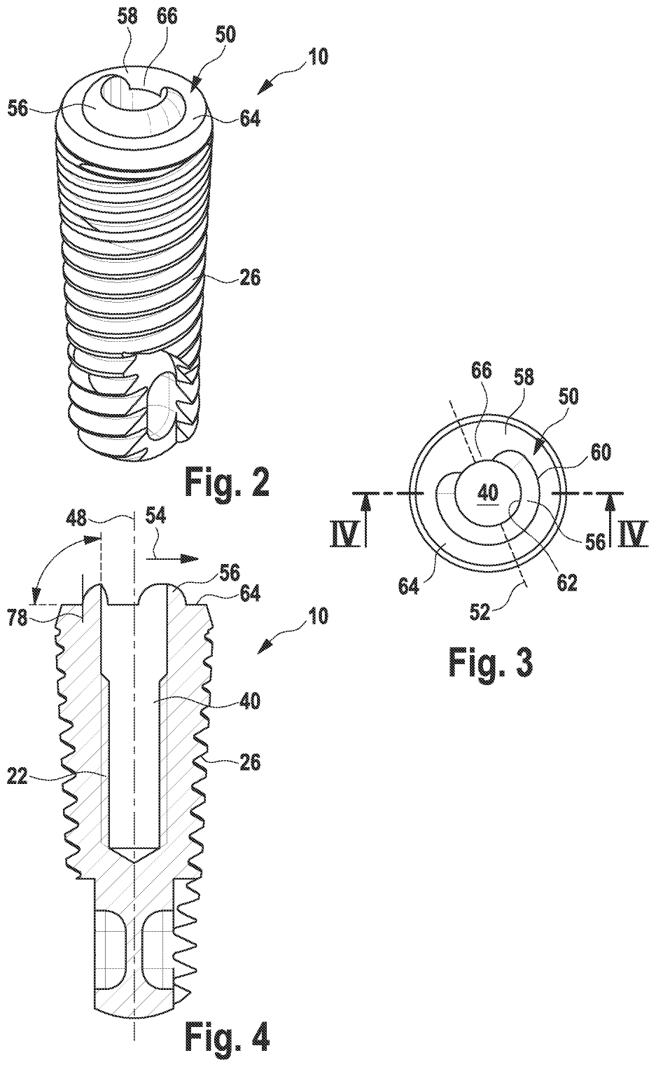

A feature of the interface 50 is that, due to its shape and configuration, it allows the superstructure 20 to be attached directly to the dental implant 10 (without the use of an interposed abutment). FIGS. 2-4 and 5-7 show two different embodiments of this interface 50, which are already known from patent application 10 2018 113 237.9.

In the embodiment shown in FIGS. 2-4, the interface 50 is configured to be non-rotationally symmetrical with respect to the longitudinal axis 48 of the dental implant 10 so as to form an anti-rotation device. It is, however, mirror-symmetrical with respect to a longitudinal section plane, which is indicated in FIG. 3 by a dashed line 52. This longitudinal section plane 52 is spanned by the longitudinal axis 48 and the radial direction 54 running orthogonally thereto. It divides the dental implant 10 into two equal halves.

The interface 50 comprises a curvature 56 and a support surface 58 surrounding the curvature 56. The curvature 56 essentially serves to absorb forces in the radial direction 54, whereas the support surface 58 serves as an axial support which essentially absorbs forces in the longitudinal direction, i.e. along the longitudinal axis 48. In the assembled state, the superstructure 20 is supported both by the curvature 56 and by the support surface 58.

The curvature 56 is convex, i.e. curved outwards. The curvature 56 is rounded, i.e. not angular. The curvature 56 extends over an angular range of at least 90° around the longitudinal axis 14. In the embodiments shown in FIGS. 2-4, this angular range is even greater than 200°.

In this embodiment, the curvature 56 is not rotationally symmetrical. Viewed in cross-section (see FIG. 4), the curvature 56 is preferably configured as a circular sector with a center angle of α=90°. However, it goes without saying that other center angles α are also possible. Likewise, the curvature 56 does not necessarily have to be circular in cross-section. It can also be elliptically shaped or configured as a free-form surface.

The outer edge 60 and the inner edge 62 of the curvature 56 preferably lie on a circular line. In the top view shown in FIG. 3, the curvature 56 is thus at least in sections annular. Accordingly, the curvature 56 forms a part of the surface of a torus.

Preferably, the curvature 56 directly adjoins to the bore 40. In the embodiment shown in FIGS. 2-4, the inner edge 62 of the curvature 56 forms the upper edge of the bore 40. The outer edge 60 of the curvature 56 preferably directly adjoins an annular portion 64 of the support surface 58. This annular portion 64 runs transversely, preferably at an angle greater than 60°, particularly preferably orthogonally to the longitudinal axis 48 of the dental implant 10. The curvature 56 projects upwards relative to this annular portion 64.

As can further be seen from FIGS. 2 and 3, the curvature 56 comprises a notch 66 on a part of its circumference. At this notch 66, the curvature 56 is interrupted. The notch 66 serves as an anti-rotation device to protect the superstructure 20 from rotating relative to the dental implant 10.

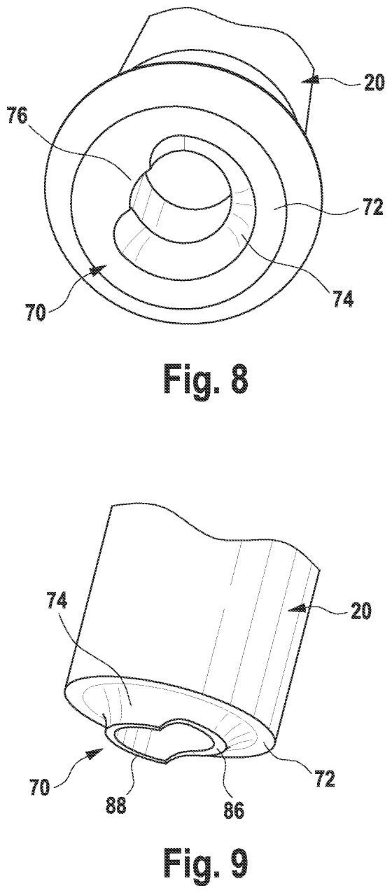

FIG. 8 shows the interface 70 formed as a counterpart on the lower side of the superstructure 20, which interface is herein referred to as the “second interface”. The interface 70 also comprises a support surface 72 having at least one annular portion. As counterpart to the convex curvature 56, the interface 70 comprises a concave recess 74. Since this concave recess 74 is interrupted by a bar 76, the dental implant 10 and the superstructure 20 can only be arranged in a single defined position relative to one another. The support surfaces 58, 72 lie flat against each other and the convex curvature 56 engages in the concave recess 74.

To form a connection between the dental implant 10 and the superstructure 20 that is as stable as possible, a tangent 78 to the outer edge 60 of the curvature 56 is preferably oriented orthogonally to the support surface 58 or the annular portion 64 (see FIG. 4). The angle of this tangent 78 to the annular portion 64 of the support surface 58 is preferably at least 60° in this embodiment of the dental implant 10. This is advantageous not only for stability, but also for ease of fabrication.

When comparing FIGS. 3 and 8, another advantage of the interfaces 50, 70 should be pointed out. By a simple modification of the interface 70 it is possible to remove the anti-rotation device. For example, by omitting the bar 76 and making the concave recess 74 all around, the anti-rotation feature required for clear positioning between the superstructure 20 and the dental implant 10 is removed. This can be advantageous, for example, if such a clear positioning is not required. This is advantageous, for example, if a bridge is mounted as superstructure 20 on the dental implant 10.

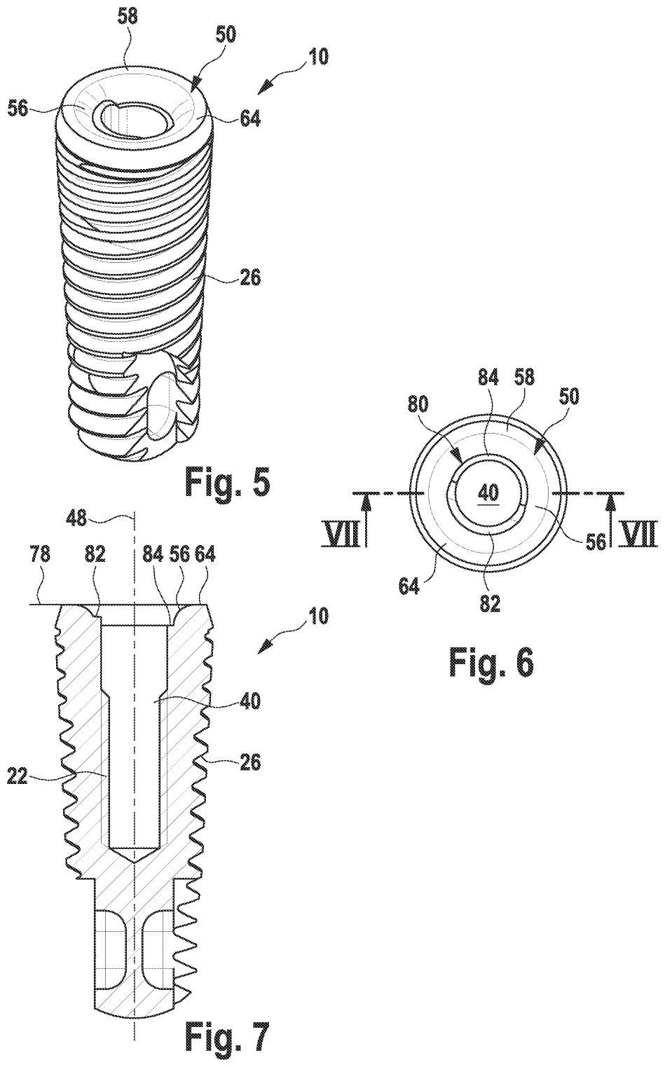

FIGS. 5-7 show a second embodiment of the dental implant 10. For the sake of simplicity, only the differences to the first embodiment shown in FIGS. 2-4 are discussed below.

In the second embodiment shown in FIGS. 5-7, the support surface 58 has a continuous annular shape. Thus, the annular portion 64 forms the entire support surface 58. The convex curvature 56 is arranged at least partially within the bore 40. It forms the upper end of the bore 40.

Another significant difference to the first embodiment is that the tangent 78 runs parallel to the annular portion 64 of the support surface 58. More specifically, the annular portion 64 of the support surface 58 transitions tangentially into the convex curvature 56 (see FIG. 7). The convex curvature 56 completely surrounds the longitudinal axis 48 in this embodiment. Thus, it extends over an angular range of 360° about the longitudinal axis 48. Accordingly, the convex curvature 56 is rotationally symmetrical according to this embodiment. Nevertheless, the interface 50 is in its entirety not rotationally symmetrical. In addition to the support surface 58 and the convexity 56, it comprises an anti-rotation section 80. Spatially considered, this anti-rotation section 80 is arranged in the bore 40 between the convex curvature 56 and the internal thread 22.

In the embodiment shown in FIGS. 5-7, the anti-rotation section 80 comprises two semicircular surfaces 82, 84 that are arranged offset to one another along the longitudinal axis 48. It is understood, however, that these two surfaces 82, 84 do not necessarily have to be semicircular. Preferably, the two surfaces 82, 84 are oriented orthogonally to the longitudinal axis 48.

FIG. 9 shows the interface 70 which serves as a counterpart to the interface 50 according to the second embodiment and is arranged on the lower side of the superstructure 20. The support surface 72 is again annular in shape. Corresponding to the convex curvature 56, a concave curvature 74 is provided on the lower side of the superstructure 20, which concave curvature in this case projects downwards from the support surface 72. As counterparts to the surfaces 82, 84, planar surfaces 86, 88 arranged adjacent to the concave curvature 74 are provided on the front end. These planar surfaces 86, 88 are also designed here as semicircular surfaces and are arranged offset to each other with respect to the longitudinal axis 48.

In the assembled state, the support surface 58 of the dental implant 10 abuts the support surface 72 of the superstructure 20, the convex curvature 56 abuts the concave curvature 74, and the surfaces 82, 84 abut the surfaces 86, 88. Again, the interfaces 50, 70 allow only a single defined orientation of the dental implant 10 and the superstructure 20 relative to each other.

Finally, it should be noted that the two embodiments of the dental implant 10 shown herein represent only two of many possible embodiments. It goes without saying that various features of these two embodiments can be easily modified without leaving the spirit and scope of the present disclosure. It is also understood that various features of these two embodiments can be combined and/or exchanged without leaving the spirit and scope of the present disclosure.

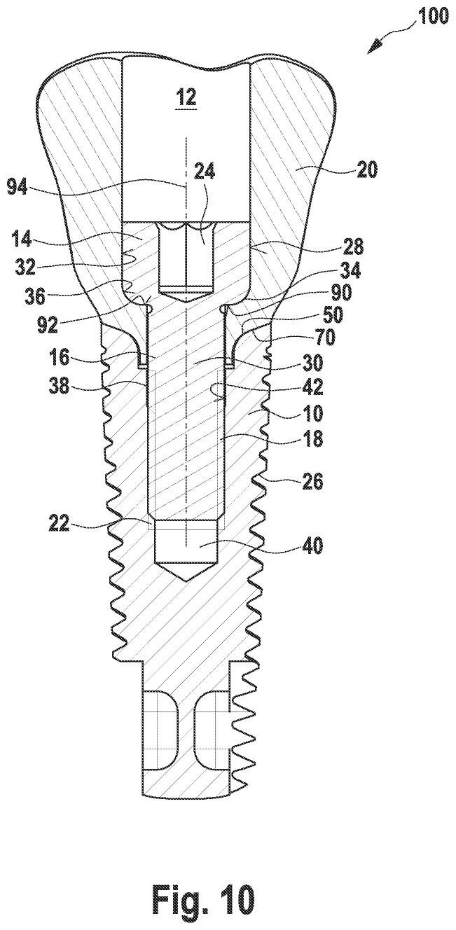

FIG. 10 shows a second embodiment of the dental prosthesis. Therein, identical or equivalent components are denoted with the same reference numerals as before.

The main difference to the first embodiment shown in FIG. 1 is the way in which the screw head 14 is configured and the corresponding shape of the superstructure 20 inside the bore 12.

The screw head 14 comprises an abutment surface 90 at its lower end, which is oriented transversely, preferably at an angle greater than 60°, particularly preferably orthogonally to the longitudinal axis 94 of the screw 30. Since the longitudinal axis 48 of the dental implant 10 coincides with the longitudinal axis 94 of the screw 30 in the assembled state of the dental prosthesis 100, the abutment surface 90 is thus also oriented transversely or, particularly preferably, orthogonally to the longitudinal axis 48 of the dental implant 10.

The abutment surface 90 is configured as an annular surface. It directly adjoins the convexly rounded chin 34 of the screw head 14. However, it is also possible that the abutment surface 90 is separated from the convexly rounded chin 34, for example, by an undercut.

In the assembled state of the dental prosthesis 100, the abutment surface 90 abuts an equivalently shaped mating abutment surface 92 of the superstructure 20. This enables direct transmission of forces in the axial direction. The resulting pull-down of the superstructure ensures an extremely stable connection between superstructure 20 and dental implant 10.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. Dental prosthesis, comprising:
a dental implant having a first external thread and an internal thread;
a superstructure having an internal bore; and
a screw that is configured to fasten the superstructure to the dental implant, wherein the screw comprises a screw head having a cylindrical or conical lateral surface and a shank which adjoins a lower end of the screw head and on which a second external thread is provided,
wherein, in an assembled state of the dental prosthesis, the screw is inserted through the internal bore of the superstructure into the dental implant and the second external thread engages the internal thread of the dental implant, and
wherein the screw head comprises a convexly rounded chin that is arranged between the cylindrical or conical lateral surface and a lower end of the screw head, wherein, in the assembled state of the dental prosthesis, the convexly rounded chin of the screw head abuts the superstructure in the internal bore.

2. Dental prosthesis according to claim 1, wherein the superstructure directly abuts the dental implant in the assembled state of the dental prosthesis.

3. Dental prosthesis according to claim 1, wherein the chin of the screw head has a round cross-section.

4. Dental prosthesis according to claim 3, wherein the round cross-section has a radius of 0.5 mm.

5. Dental prosthesis according to claim 1, wherein the cylindrical or conical lateral surface of the screw head abuts the superstructure in the internal bore.

6. Dental prosthesis according to claim 1, wherein the shank comprises, in an upper region adjacent the lower end of the screw head, a non-threaded cylindrical portion that abuts the dental implant in the assembled state of the dental prosthesis.

7. Dental prosthesis according to claim 6, wherein the cylindrical portion of the shank has a diameter equal to a nominal diameter of the second external thread.

8. Dental prosthesis according to claim 1, wherein the screw head has its largest diameter in a region of the cylindrical or conical lateral surface.

9. Dental prosthesis according to claim 1, wherein the superstructure comprises a ceramic material.

10. Dental prosthesis according to claim 1, wherein the superstructure is manufactured on a milling machine using a 3D model.

11. Dental prosthesis according to claim 1, wherein the screw head comprises at the lower end an abutment surface which is oriented transversely to a longitudinal axis of the screw and abuts a mating abutment surface of the superstructure in the assembled state of the dental prosthesis.

12. Dental prosthesis according to claim 11, wherein the abutment surface adjoins the convexly rounded chin.

13. Dental prosthesis according to claim 11, wherein the abutment surface is of annular shape.

14. Dental prosthesis according to claim 11, wherein the abutment surface is oriented orthogonally to the longitudinal axis of the screw.
